(19) United States
(12) Patent Application Publication
(10) Pub. No.: US 2021/0288305 A1
(43) Pub. Date: Sep. 16, 2021

(54) POSITIVE ELECTRODE ACTIVE MATERIAL FOR NONAQUEOUS ELECTROLYTE SECONDARY BATTERIES, POSITIVE ELECTRODE FOR NONAQUEOUS ELECTROLYTE SECONDARY BATTERIES, NONAQUEOUS ELECTROLYTE SECONDARY BATTERY, AND METHOD FOR PRODUCING POSITIVE ELECTRODE ACTIVE MATERIAL FOR NONAQUEOUS ELECTROLYTE SECONDARY BATTERIES

(71) Applicant: Panasonic Intellectual Property MAnagement Co., Ltd., Osaka-shi, Osaka (JP)

(72) Inventors: Daizo Jito, Osaka (JP); Takeshi Ogasawara, Hyogo (JP)

(73) Assignee: Panasonic Intellectual Property Management Co., Ltd., Osaka-shi, Osaka (JP)

(21) Appl. No.: 16/323,371

(22) PCT Filed: Jul. 26, 2017
(86) PCT No.: PCT/JP2017/026953

§ 371 Date: Feb. 5, 2019

(30) Foreign Application Priority Data
Aug. 10, 2016 (JP) 2016-158133

(51) Int. Cl. H01M 4/131; H01M 4/134; H01M 4/525; H01M 4/505; H01M 4/1391; H01M 4/1395; H01M 4/04; H01M 10/0525

(52) U.S. Cl. CPC H01M 4/131; H01M 4/134; H01M 4/525; H01M 4/505; H01M 2004/028; H01M 4/1395; H01M 4/0471; H01M 10/0525; H01M 4/1391

(57) ABSTRACT

An object of the invention is to provide a positive electrode active material for nonaqueous electrolyte secondary batteries that prevents low capacity recovery after high-temperature storage. A nonaqueous electrolyte secondary battery according to the present invention includes secondary particles of a lithium transition metal oxide resulting from the aggregation of primary particles of the oxide, secondary particles of a rare earth compound resulting from the aggregation of primary particles of the compound, and a magnesium compound. The secondary particles of the rare earth compound are adhering to depressions formed between adjacent primary particles of the lithium transition metal oxide on the surface of the secondary particles of the lithium transition metal oxide and also to each of the primary particles forming the depressions. The magnesium compound is adhering to the surface of the secondary particles of the lithium transition metal oxide.

### TECHNICAL FIELD

The present disclosure relates to a positive electrode active material for nonaqueous electrolyte secondary batteries, a positive electrode for nonaqueous electrolyte secondary batteries, a nonaqueous electrolyte secondary battery, and a method for producing a positive electrode active material for nonaqueous electrolyte secondary batteries.

### BACKGROUND ART

In recent years, a need has existed for nonaqueous electrolyte secondary batteries with a high capacity that allows for long use, and with improved power characteristics that allow high-current charge and discharge to be repeated within a comparatively short period of time.

For example, PTL 1 suggests that placing an element in group 3 of the periodic table on the surface of base particles as a positive electrode active material will limit the degradation of charge storage characteristics by inhibiting the reaction between the positive electrode active material and the electrolyte even when the charging voltage is high.

PTL 2 suggests that dissolving magnesium (Mg) in a solid positive electrode active material will improve discharge performance by reducing the crystallinity of the positive electrode.

### CITATION LIST

### Patent Literature

PTL 1: International Publication No. 2005/008812

PTL 2: International Publication No. 2014/097569

### SUMMARY OF INVENTION

When it comes to the problems that need to be mitigated with the battery characteristics of a nonaqueous electrolyte secondary battery, another important goal is to prevent low capacity recovery after high-temperature storage. Capacity recovery after high-temperature storage is the percentage of the capacity of a battery discharged once after high-temperature storage and then charged and discharged again (recovered capacity) to that before the high-temperature storage (capacity before storage) and is expressed by the following equation.

Capacity recovery after high-temperature storage=(Recovered capacity/Capacity before storage)×100

Therefore, an object of the present invention is to provide a positive electrode active material for nonaqueous electrolyte secondary batteries that prevents low capacity recovery after high-temperature storage.

A nonaqueous electrolyte secondary battery according to the present disclosure includes secondary particles of a lithium transition metal oxide resulting from the aggregation of primary particles of the oxide, secondary particles of at least one rare earth compound resulting from the aggregation of primary particles of the compound, and a magnesium compound. The secondary particles of the rare earth compound are adhering to depressions formed between adjacent primary particles of the lithium transition metal oxide on the surface of the secondary particles of the lithium transition metal oxide and also to each of the primary particles forming the depressions. The magnesium compound is adhering to the surface of the secondary particles of the lithium transition metal oxide.

According to the present disclosure, there is provided a positive electrode active material for nonaqueous electrolyte secondary batteries that prevents low capacity recovery after high-temperature storage.

### BRIEF DESCRIPTION OF DRAWINGS

FIG. 1 is a front view of a nonaqueous electrolyte secondary battery that includes a positive electrode active material according to an embodiment.

FIG. 2 is a cross-section along line II-II in FIG. 1.

FIG. 3 is a cross-sectional diagram illustrating a positive electrode active material particle as an example of an embodiment and an enlarged view of part of the particle.

FIG. 4 is a partially enlarged cross-section of a positive electrode active material particle for explaining the adhesion of the magnesium compound to be described.

### DESCRIPTION OF EMBODIMENTS

The following describes an example of an embodiment in detail with reference to the drawings.

The present disclosure is not limited to the embodiment and can be implemented with any necessary modification within the gist thereof. The drawings referred to in describing the embodiment are schematic.

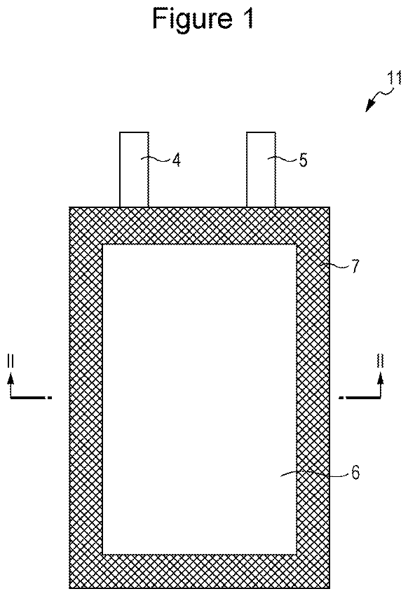

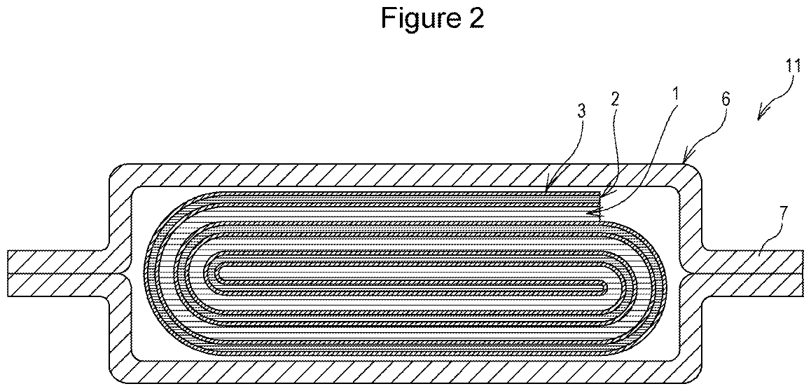

FIG. 1 is a front view of a nonaqueous electrolyte secondary battery that includes a positive electrode active material according to this embodiment. FIG. 2 is a cross-section along line II-II in FIG. 1. As illustrated in FIGS. 1 and 2, the nonaqueous electrolyte secondary battery 11 includes a positive electrode 1, a negative electrode 2, and a nonaqueous electrolyte (not illustrated). The positive electrode 1 and negative electrode 2 are wound with a separator 3 therebetween, forming a flat electrode assembly together with the separator 3. The nonaqueous electrolyte secondary battery 11 includes a positive electrode current collector tab 4, a negative electrode current collector tab 5, and an aluminum laminate sheath 6 that has a closed portion 7 formed by heat-sealing edges. The flat electrode assembly and the nonaqueous electrolyte are housed in the aluminum laminate sheath 6. The positive electrode 1 is coupled to the positive electrode current collector tab 4, and the negative electrode 2 to the negative electrode current collector tab 5, forming a structure capable of charge and discharge as a secondary battery.

Although the example illustrated in FIGS. 1 and 2 represents a laminate-film-packed battery that includes a flat electrode assembly, the application of the present disclosure is not limited to this. The shape of the battery may be, for example, a cylindrical battery, a prismatic battery, or a coil battery.

The following describes the individual elements of the nonaqueous electrolyte secondary battery 11.

### [Positive Electrode]

The positive electrode is composed of, for example, a positive electrode current collector, such as metallic foil, and a positive electrode active material layer formed on the positive electrode current collector. The positive electrode current collector can be, for example, a foil of a metal that is stable within the range of positive electrode potentials, such as aluminum, or a film with a surface layer made from such a metal. The positive electrode active material layer preferably contains a conductor and a binder besides a positive electrode active material. The positive electrode can be prepared by, for example, coating a positive electrode current collector with a positive electrode mixture slurry that contains materials including a positive electrode active material, a conductor, and a binder, drying the coating, and then rolling the coating to form a positive electrode active material layer on both sides of the current collector.

The conductor is used to increase the electrical conductivity of the positive electrode active material layer. Examples of conductors include carbon materials, such as carbon black, acetylene black, Ketjenblack, and graphite. One of these may be used alone, or a combination of two or more may be used.

The binder is used to maintain good contact between the positive electrode active material and conductor and to improve the adhesion of the positive electrode active material and other materials to the surface of the positive electrode current collector. Examples of binders include fluoropolymers, such as polytetrafluoroethylene (PTFE) and polyvinylidene fluoride (PVdF), polyacrylonitrile (PAN), polyimide resins, acrylic resins, and polyolefin resins. These resins may be used in combination with carboxymethyl cellulose (CMC) or its salt (e.g., CMC-Na, CMC-K, or CMC-NH₄; a partially neutralized salt also works) or polyethylene oxide (PEO). One of these may be used alone, or a combination of two or more may be used.

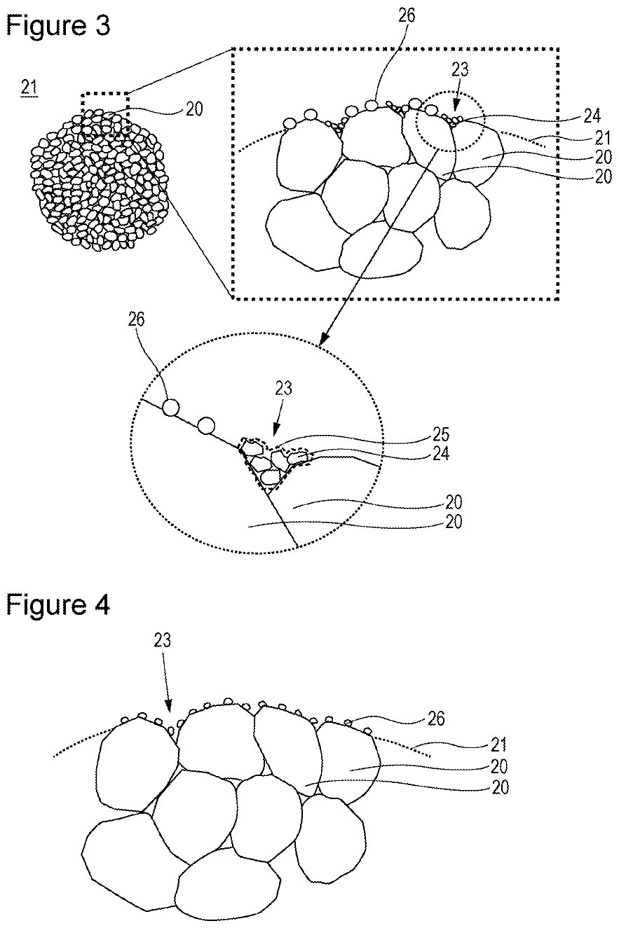

The following describes in detail positive electrode active material particles as an example of an embodiment with reference to FIG. 3.

FIG. 3 is a cross-sectional diagram illustrating a positive electrode active material particle as an example of an embodiment and an enlarged view of part of the particle.

As illustrated in FIG. 3, a particle of the positive electrode active material includes a secondary particle 21 of a lithium transition metal oxide resulting from the aggregation of primary particles 20 of the lithium transition metal oxide, secondary particles 25 of a rare earth compound resulting from the aggregation of primary particles 24 of the rare earth compound, and a magnesium compound 26. The secondary particles 25 of the rare earth compound are adhering to the depressions 23 formed between adjacent primary particles 20 of the lithium transition metal oxide on the surface of the secondary particle 21 of the lithium transition metal oxide, and also to each of the primary particles 20 forming the depressions 23. The magnesium compound 26 is adhering to the surface of the secondary particle 21 of the lithium transition metal oxide.

When a secondary particle 25 of the rare earth compound is adhering to each of the primary particles 20 of the lithium transition metal oxide forming a depression 23, the secondary particle 25 is adhering to the surface of the at least two adjacent primary particles 20 at the depression 23. When viewing a cross-section of a particle of the lithium transition metal oxide by way of example, the positive electrode active material particles according to this embodiment have the secondary particles 25 of the rare earth compound adhering to the surface of both of the two adjacent primary particles 20 of the lithium transition metal oxide on the surface of the secondary particle 21. It is to be noted that some secondary particles 25 of the rare earth compound may be adhering to the outside of the depressions 23 on the surface of the secondary particle 21, but most of the secondary particles 25, for example 80% or more, 90% or more, or substantially 100%, are present in the depressions 23.

FIG. 4 is a partially enlarged cross-section of a positive electrode active material particle for explaining the adhesion of the magnesium compound to be described. In FIG. 4, the rare earth compound (primary particles 24 and secondary particles 25) is omitted so that the adhesion of the magnesium compound is understood clearly. As illustrated in FIG. 4, the magnesium compound 26 is adhering not only to the outside of the depressions on the surface of the primary particle 21 but also to the surface of the depressions 23. In the depressions 23, therefore, the magnesium compound 26 and the rare earth compound, not illustrated, coexist. Although not illustrated, the magnesium compound 26 may be adhering to the surface of, for example, secondary particles of the rare earth compound. The magnesium compound 26 may be in the form of primary particles or secondary particles.

The positive electrode active material particles according to this embodiment prevent low capacity recovery of the battery after high-temperature storage owing to the secondary particles of the rare earth compound adhering to both of adjacent primary particles of the lithium transition metal oxide and the magnesium compound adhering to the surface of secondary particles of the lithium transition metal oxide. Although the mechanism behind this is not sufficiently clear, a possibility is the following.

In general, storing a battery at a high temperature can cause the surface of secondary particles of the lithium transition metal oxide to be altered by the reaction of the surface of secondary particles of the lithium transition metal oxide (including the near-surface inside of the primary particles of the lithium transition metal oxide present near the surface of the secondary particles) with the electrolyte and other materials. It appears that this alteration of the surface of secondary particles affects the capacity recovery after high-temperature storage. The presence of a magnesium compound on the surface of secondary particles of the lithium transition metal oxide as in this embodiment, however, seems to control the alteration of the surface of secondary particles of the lithium transition metal oxide by reducing the reactivity of the secondary particles with the electrolyte and other materials.

Rare earth compounds are also effective in controlling the alteration of the surface of secondary particles of a lithium transition metal oxide, but when a battery is stored at a high temperature, the rare earth compound itself may be altered by reacting with the electrolyte and other materials. This altered rare earth compound appears to promote the reaction during high-temperature storage between the electrolyte and the surface of secondary particles of the lithium transition metal oxide, making the surface of the secondary particles more prone to alteration. The presence of a magnesium compound on the surface of secondary particles of the lithium transition metal oxide as in this embodiment, however, seems to control the alteration of the rare earth compound, too, by reducing the reactivity of the rare earth compound with the electrolyte and other materials during high-temperature storage. That is, the magnesium compound not only inhibits the reaction of the surface of secondary particles of the lithium transition metal oxide with the electrolyte and other materials but also controls the alteration of the rare earth compound. To summarize, the inventors believe, the magnesium compound and the rare earth compound, whose alteration is limited, work in synergy to control the alteration of the surface of secondary particles of the lithium transition metal oxide effectively, thereby preventing low capacity recovery after high-temperature storage.

Through extensive research, moreover, the inventors have found that rare earth compounds are more effective than magnesium compounds in controlling the alteration of a lithium transition metal oxide. Capacity recovery after high-temperature storage is influenced more by the alteration of near-surface regions of the primary particles of the lithium transition metal oxide present near the surface of secondary particles than by surface alteration of secondary particles of the lithium transition metal oxide. Hence, the inventors believe, placing the rare earth compound in the depressions in the surface of the secondary particles as in this configuration will improve the capacity recovery after high-temperature storage more effectively. The research also revealed that the magnesium compound effectively controls surface alteration of the rare earth compound particularly when at the depressions 23 illustrated in FIG. 3, the secondary particles 25 of the rare earth compound are present on the surface of the at least two adjacent primary particles 20. When the secondary particles 25 of the rare earth compound in FIG. 3 are dispersed uniformly on the surface of the secondary particles 21 of the lithium transition metal oxide, the effectiveness of the magnesium compound in controlling the alteration of the surface of the rare earth compound may be low, and the aforementioned synergy may be insufficient.

The rare earth compound is preferably at least one selected from rare earth hydroxides, oxyhydroxides, oxides, carbonates, phosphates, and fluorides. Among these, rare earth hydroxides are preferred, for example in terms of adhesiveness to secondary particles of the lithium transition metal oxide.

The rare earth compound contains at least one rare earth element selected from scandium, yttrium, lanthanum, cerium, praseodymium, neodymium, samarium, europium, gadolinium, terbium, dysprosium, holmium, erbium, thulium, ytterbium, and lutetium. Among these, neodymium, samarium, and erbium are particularly preferred. Compounds of neodymium, samarium, and erbium are remarkably effective compared with other rare earth compounds, for example in controlling the surface alteration that can occur on the surface of the secondary particles 21 (interfaces between primary surfaces 20) of the lithium transition metal oxide.

Specific examples of rare earth compounds include hydroxides, such as neodymium hydroxide, samarium hydroxide, and erbium hydroxide; oxyhydroxides, such as neodymium oxyhydroxide, samarium oxyhydroxide, and erbium oxyhydroxides; phosphates, such as neodymium phosphate, samarium phosphate, and erbium phosphate; carbonates, such as neodymium carbonate, samarium carbonate, and erbium carbonate; oxides, such as neodymium oxide, samarium oxide, and erbium oxide; and fluorides, such as neodymium fluoride, samarium fluoride, and erbium fluoride.

The average diameter of the primary particles of the rare earth compound is preferably 5 nm or more and 100 nm or less, more preferably 5 nm or more and 80 nm or less.

The average diameter of the secondary particles of the rare earth compound is preferably 100 nm or more and 400 nm or less, more preferably 150 nm or more and 300 nm or less. Too large an average diameter of the secondary particles of the rare earth compound may result in insufficient prevention of low capacity recovery after high-temperature storage because of the decreased number of depressions on the lithium transition metal oxide to which these secondary particles can adhere to. Too small an average diameter of the secondary particles of the rare earth compound means that these secondary particles touch each primary particle of the lithium transition metal oxide only in small areas in the depressions on the lithium transition metal oxide. This may result in reduced effectiveness in controlling the alteration that occurs on the surface of adjacent primary particles of the lithium transition metal oxide at the depressions.

The percentage of the rare earth compound (amount of adhering compound) is preferably 0.005% by mass or more and 0.5% by mass or less on a rare earth element basis, more preferably 0.05% by mass or more and 0.3% by mass or less, of the total mass of the lithium transition metal oxide. Too low a percentage may result in insufficient effectiveness of the rare earth compound because of the small amount of rare earth compound adhering to the depressions on the lithium transition metal oxide. Too high a percentage may affect initial charge and discharge characteristics because the rare earth compound covers not only the depressions but also the surface of the secondary particles of the lithium transition metal oxide.

The magnesium compound can be, for example, magnesium hydroxide, magnesium sulfate, magnesium nitrate, magnesium oxide, magnesium carbonate, a magnesium halide, a dialkoxy magnesium, or a dialkyl magnesium. Among these, magnesium hydroxide is preferred, for example in terms of adhesiveness to secondary particles of the lithium transition metal oxide.

The amount of adhering magnesium compound is preferably 0.03 mol % or more and 0.5 mol % or less of the total number of moles of non-lithium metal elements in the lithium transition metal oxide. Too small an amount of adhesion may result in, for example, low effectiveness in controlling the alteration of the surface of secondary particles of the lithium transition metal oxide and of the surface of the rare earth compound, and too large an amount of adhesion leads to increased surface resistance of the secondary particles of the lithium transition metal oxide that may, for example, affect initial charge and discharge characteristics.

The primary particles and secondary particles of the magnesium compound are not limited in size, but preferably are sizes similar to the rare earth compound.

The average diameter of the primary particles of the lithium transition metal oxide is preferably 100 nm or more and 5 μm or less, more preferably 300 nm or more and 2 μm or less. Too small an average diameter of these primary particles may cause the primary particles to be divided easily by the expansion and shrinkage of the positive electrode active material during charge and discharge cycles because of too many interfaces between primary particles of the lithium transition metal oxide including those inside secondary particles. Too large an average particle diameter may result in reduced output power, at low temperatures in particular, because of too few interfaces between primary particles of the lithium transition metal oxide including those inside secondary particles.

The average diameter of the secondary particles of the lithium transition metal oxide is preferably 2 μm or more and 40 μm or less, more preferably 4 μm or more and 20 μm or less. Too small an average diameter of these secondary particles may result in reduced packing density of the positive electrode active material and cause the capacity not to be sufficiently high. Too large an average particle diameter may result in insufficient output power, at low temperatures in particular. It is to be noted that the secondary particles result from the bonding (aggregation) of primary particles, and, therefore, the primary particles cannot be larger than the secondary particles.

The average diameters can be determined by observing the surface and a cross-section of the active material particles and measuring the diameter of particles, for example dozens of particles for each, using a scanning electron microscope (SEM). The average diameter of the primary particles of the rare earth compound is the size measured along the surface of the active material, not in the direction of thickness.

The central diameter (D50) of the secondary particles of the lithium transition metal oxide is preferably 3 μm or more and 30 μm or less, more preferably 5 μm or more and 20 μm or less. The central diameter (D50) can be measured by light diffraction and scattering. The central diameter (D50) represents the particle diameter at the cumulative 50% volume in the particle size distribution of the secondary particles and is also referred to as the median diameter (by volume).

The lithium transition metal oxide can be of any type but preferably contains, for example, at least one of nickel (Ni), cobalt (Co), manganese (Mn), and aluminum (Al), more preferably nickel (Ni), cobalt (Co), and aluminum (Al). Specific examples of preferred oxides include lithium nickel-manganese composite oxides, lithium nickel-cobalt-manganese composite oxides, and lithium nickel-cobalt composite oxides, and specific examples of more preferred oxides include lithium nickel-cobalt-aluminum composite oxides. In a lithium nickel-cobalt-aluminum composite oxide, the percentage of Ni is preferably 80 mol % or more of the total number of moles of non-lithium (Li) metal elements. This ensures, for example, a high capacity of the positive electrode and, as described hereinafter, helps induce the proton exchange that occurs at the interfaces between primary particles of the lithium transition metal oxide.

With a lithium transition metal oxide having a percentage of Ni of 80 mol % or more, proton exchange between the lithium therein and water easily occurs in water owing to a high percentage of trivalent Ni. Resulting from the proton exchange, a large amount of LiOH surfaces from the inside of particles of the lithium transition metal oxide. This makes the alkali (OH⁻) concentrations in the spaces between adjacent primary particles of the lithium transition metal oxide higher than those in the surrounding areas on the surface of secondary particles. The alkali in the depressions formed between primary particles of the lithium transition metal oxide attracts primary particles of the rare earth compound, helping them adhere to the depressions and aggregate into secondary particles. With a lithium transition metal oxide having a percentage of Ni of less than 80 mol %, however, the alkali concentrations in the spaces between primary particles of the lithium transition metal oxide are almost the same as those in the surrounding areas because the aforementioned proton exchange does not easily occur. Primary particles of the rare earth compound separating out may bond together into secondary particles, but in the course of adhering to the surface of the lithium transition metal oxide, they may stick preferentially to the outside of the depressions 23 (projections). The magnesium compound is likely to adhere to the surface of secondary particles of the lithium transition metal oxide uniformly because it is not as responsive as the rare earth compound to alkali concentration.

It is preferred, for example in terms of increasing the capacity, that the percentage of Co in the lithium transition metal oxide be 7 mol % or less, more preferably 5 mol % or less, of the total number of moles of non-Li metal elements. When Co is too small in quantity, surface alterations are controlled even more effectively because structural changes during charge and discharge, and therefore breaks at the interfaces between particles, can be more likely to occur.

The attachment of the rare earth compound to the surface of the secondary particles of the lithium transition metal oxide can be achieved by, for example, adding an aqueous solution of the rare earth compound to a suspension containing the lithium transition metal oxide. While adding the aqueous solution of the rare earth compound to the suspension containing the lithium transition metal oxide, it is desirable to adjust the pH of the suspension to the range of 11.5 or more, preferably 12 or more. Treatment under these conditions helps particles of the rare earth compound adhere unevenly to the surface of secondary particles of the lithium transition metal oxide. A pH of the suspension between 6 and 10 often results in uniform adhesion of particles of the rare earth compound to the entire surface of secondary particles of the lithium transition metal oxide. A pH less than 6 can cause the lithium transition metal oxide to dissolve at least in part.

The pH of the suspension is desirably adjusted to the range of 11.5 or more and 14 or less, particularly preferably 12 or more and 13 or less. A pH greater than 14 may result in too large primary particles of the rare earth compound. Such a pH, moreover, may lead to an excess of residual alkali inside particles of the lithium transition metal oxide. The residual alkali can cause the positive electrode mixture slurry to gel during its preparation, potentially affecting the storage stability of the battery.

Adding an aqueous solution of the rare earth compound to a suspension containing the lithium transition metal oxide results in a hydroxide of the rare earth element separating out when the aqueous solution is simply an aqueous solution. When the aqueous solution contains carbon dioxide sufficiently, a carbonate of the rare earth element separates out. Adding the phosphate ion sufficiently to the suspension leads to a phosphate of the rare earth element separating out on the surface of particles of the lithium transition metal oxide. By controlling ions dissolved in the suspension, it is possible to obtain even a mixture of rare earth compounds including a hydroxide and a fluoride for example.

The lithium transition metal oxide with the rare earth compound attached to its surface is preferably heated. Heat treatment strengthens the adhesion of the rare earth compound to the interfaces between primary particles of the lithium transition metal oxide and can thereby make the compound more effective in controlling the surface alteration that occurs at the interfaces between the primary particles as well as in bonding the primary particles together.

The heat treatment of the lithium transition metal oxide with the rare earth compound attached to its surface is preferably performed in a vacuum. The water in the suspension used to attach the rare earth compound penetrates and reaches the inside of particles of the lithium transition metal oxide, and when secondary particles of the rare earth compound are adhering to the depressions on the lithium transition metal oxide, the water coming from the inside does not easily leave during drying. For this reason, it is preferred to perform the heat treatment in a vacuum to remove the water efficiently. An increased carry-over of water from the positive electrode active material into the battery can cause the surface of the active material to be altered by the product of reaction between the water and the nonaqueous electrolyte.

The aqueous solution containing the rare earth compound can be a solution of, for example, an acetate, nitrate, sulfate, oxide, or chloride in a solvent that is primarily water. In particular, when a rare earth oxide is used, the aqueous solution may be one that contains a sulfate, chloride, or nitrate of the rare earth element as a result of being obtained by dissolving the oxide in an acid such as sulfuric acid, hydrochloric acid, or nitric acid.

Attaching the rare earth compound to the surface of secondary particles of the lithium transition metal oxide by dry mixing of the lithium transition metal oxide and the rare earth compound often results in random attachment of particles of the rare earth compound to the surface of secondary particles of the lithium transition metal oxide. That is, it is difficult to attach the rare earth compound selectively to depressions on the lithium transition metal oxide. With dry mixing, moreover, the rare earth compound may be insufficiently effective in fastening (bonding) primary particles of the lithium transition metal oxide together because by this technique it is difficult to attach the compound to the lithium transition metal oxide firmly. Dry mixing can also cause the rare earth compound to come off the lithium transition metal oxide easily, for example while the positive electrode active material particles are mixed with materials like a conductor and a binder to give a positive electrode mixture.

The attachment of the magnesium compound to the surface of the secondary particles of the lithium transition metal oxide is similar to that of the rare earth compound and can be achieved by, for example, adding an aqueous solution of the magnesium compound to a suspension containing the lithium transition metal oxide. Other methods may alternatively be used, such as spraying an aqueous solution of the magnesium compound onto the lithium transition metal oxide. The aqueous solution of the magnesium compound can be a solution of, for example, an acetate, nitrate, sulfate, oxide, or chloride in a solvent that is primarily water.

The attachment of the magnesium compound can be before, after, or at the same time as that of the rare earth compound, but when the attachment of the rare earth compound includes heat treatment, it is desirable to attach the magnesium compound after attaching the rare earth compound (after the heat treatment). At certain heating temperatures, the magnesium compound may disappear from the surface of secondary particles of the lithium transition metal oxide as a result of magnesium dissolving in the lithium transition metal oxide. The lithium transition metal oxide itself, however, may contain elemental Mg. That is, it is acceptable to attach the magnesium compound to the lithium transition metal oxide, heat the oxide to dissolve the magnesium compound therein, and then attach the magnesium compound to the lithium transition metal oxide once again.

The particles of the lithium transition metal oxide with the magnesium and rare earth compounds attached thereto do not need to be the only positive electrode active material. A mixture of the lithium transition metal oxide and an extra positive electrode active material can also be used. The extra positive electrode active material can be any compound capable of reversible insertion and extraction of lithium ions, and examples include compounds having a layered structure that maintains a stable crystal architecture even after the insertion or extraction of lithium ions, such as lithium cobaltate and lithium nickel cobalt manganate; compounds having the spinel structure, such as lithium manganese oxide and lithium nickel manganese oxide; and compounds having the olivine structure. Positive electrode active materials having equal particle diameters or different particle diameters may be used.

### [Negative Electrode]

The negative electrode is composed of, for example, a negative electrode current collector, such as metallic foil, and a negative electrode mixture layer formed on the negative electrode current collector. The negative electrode current collector can be, for example, a foil of a metal that is stable within the range of negative electrode potentials, such as copper, or a film with a surface layer made from such a metal. The negative electrode mixture layer preferably contains a binder besides a negative electrode active material. The negative electrode can be prepared by, for example, coating a negative electrode current collector with a negative electrode mixture slurry that contains materials such as a negative electrode active material and a binder, drying the coating, and then rolling the coating to form a negative electrode active material layer on both sides of the current collector.

The negative electrode active material can be any material capable of reversible absorption and release of lithium ions and can be, for example, a carbon material, such as natural graphite or artificial graphite; a metal that alloys with lithium, such as silicon (Si) or tin (Sn); or an alloy or composite oxide that contains Si, Sn, or a similar metal element. One negative electrode active material may be used alone, or a combination of two or more may be used.

The binder can be, as in the positive electrode, a fluoropolymer, PAN, a polyimide resin, an acrylic resin, or a polyolefin resin for example. When mixture slurry is prepared using an aqueous solvent, it is preferred to use, for example, CMC or its salt (e.g., CMC-Na, CMC-K, or CMC-NH₄; a partially neutralized salt also works), styrene-butadiene rubber (SBR), polyacrylic acid (PAA) or its salt (e.g., PAA-Na or PAA-K; a partially neutralized salt also works), or polyvinyl alcohol (PVA).

### [Separator]

The separator is a porous sheet that has ionic permeability and insulating properties. Specific examples of porous sheets include microporous thin film, woven fabric, and nonwoven fabric. Preferred materials for the separator include polyolefin resins, such as polyethylene and polypropylene, and cellulose. The separator may be a multilayer body having a cellulose fiber layer and a layer of fibers of a thermoplastic resin, such as a polyolefin resin. A multilayer separator including a polyethylene layer and a polypropylene layer also works, and a separator with its surface coated, for example with an aramid resin, may also be used.

At the interface between the separator and at least one of the positive and negative electrodes, there may be a filler layer containing inorganic filler. Examples of inorganic fillers include an oxide and a phosphate containing at least one of titanium (Ti), aluminum (Al), silicon (Si), and magnesium (Mg) as well as such an oxide or phosphate with its surface coated, for example with a hydroxide. The filler layer can be formed by, for example, coating the surface of the positive electrode, negative electrode, or separator with a slurry that contains such a filler.

### [Nonaqueous Electrolyte]

The nonaqueous electrolyte contains a nonaqueous solvent and a solute dissolved in the nonaqueous solvent. Examples of nonaqueous solvents that can be used include esters, ethers, nitriles, amides, such as dimethylformamide, isocyanates, such as hexamethylene diisocyanate, and solvent mixtures containing two or more of these. The nonaqueous solvent may contain a halogenated derivative, resulting from replacing at least one or more of hydrogens with fluorine or any other halogen, of these solvents.

Examples of the esters include cyclic carbonates, such as ethylene carbonate (EC), propylene carbonate (PC), and butylene carbonate; linear carbonates, such as dimethyl carbonate (DMC), methyl ethyl carbonate (EMC), diethyl carbonate (DEC), methyl propyl carbonate, ethyl propyl carbonate, and methyl isopropyl carbonate; cyclic carboxylates, such as γ-butyrolactone and γ-valerolactone; and linear carboxylates, such as methyl acetate, ethyl acetate, propyl acetate, methyl propionate (MP), and ethyl propionate.

Examples of the ethers include cyclic ethers, such as 1,3-dioxolane, 4-methyl-1,3-dioxolane, tetrahydrofuran, 2-methyltetrahydrofuran, propylene oxide, 1,2-butylene oxide, 1,3-dioxane, 1,4-dioxane, 1,3,5-trioxane, furan, 2-methylfuran, 1,8-cineole, and crown ethers; and linear ethers, such as 1,2-dimethoxyethane, diethyl ether, dipropyl ether, diisopropyl ether, dibutyl ether, dihexyl ether, ethyl vinyl ether, butyl vinyl ether, methyl phenyl ether, ethyl phenyl ether, butyl phenyl ether, pentyl phenyl ether, methoxytoluene, benzyl ethyl ether, diphenyl ether, dibenzyl ether, o-dimethoxybenzene, 1,2-diethoxyethane, 1,2-dibutoxyethane, diethylene glycol dimethyl ether, diethylene glycol diethyl ether, diethylene glycol dibutyl ether, 1,1-dimethoxymethane, 1,1-diethoxyethane, triethylene glycol dimethyl ether, and tetraethylene glycol dimethyl ether.

Examples of the nitriles include acetonitrile, propionitrile, butyronitrile, valeronitrile, n-heptanenitrile, succinonitrile, glutaronitrile, adiponitrile, pimelonitrile, 1,2,3-propanetricarbonitrile, and 1,3,5-pentanetricarbonitrile.

The halogenated derivative is preferably, for example, a fluorinated cyclic carbonate, such as fluoroethylene carbonate (FEC), a fluorinated linear carbonate, or a fluorinated linear carboxylate, such as fluoromethyl propionate (FMP).

The solute can be a known and conventional solute and can be, for example, LiPF₆, LiBF₄, LiCF₃SO₃, LiN(FSO₂)₂, LiN(CF₃SO₂)₂/LiN(C₂F₅SO₂)₂/LiN(CF₃SO₂)(C₄F₉SO₂) LiC(C₂F₅SO₂)₃, or LiAsF₆, which are fluorine-containing lithium salts. It is also possible to use a solute obtained by adding a lithium salt other than fluorine-containing lithium salts [a lithium salt that contains one or more of the elements P, B, O, S, N, and Cl (e.g., LiClO₄)] to a fluorine-containing lithium salt. It is particularly preferred that the electrolyte contain a fluorine-containing lithium salt and a lithium salt in which the anion is an oxalato complex because this helps form a stable coating on the surface of the negative electrode even under high-temperature conditions.

Examples of the lithium salts in which the anion is an oxalato complex include LiBOB [lithium-bisoxalatoborate], Li[B(C₂O₄)F₂]/Li[P(C₂O₄)F₄], and Li[P(C₂O₄)₂F₂]. Among these, it is particularly preferred to use FLiBOB, which helps form a stable coating on the negative electrode. One solute may be used alone, or a mixture of two or more may be used.

The nonaqueous electrolyte can be used with an anti-overcharge additive therein. By way of example, cyclohexylbenzene (CHB) can be used. Others can also be used including benzene; benzene derivatives, such as biphenyl, 2-methylbiphenyl and other alkylbiphenyls, terphenyl, partially hydrogenated terphenyls, naphthalene, toluene, anisole, cyclopentylbenzene, t-butylbenzene, and t-amylbenzene; phenyl ether derivatives, such as phenyl propionate and acetate-3 phenylpropyl. One of these may be used alone, or a mixture of two or more may be used.

### EXAMPLES

The following describes the present disclosure in further detail by giving examples, but the present disclosure is not limited to these experimental examples.

### First Experiment

### Experimental Example 1

### [Preparation of a Positive Electrode Active Material]

A nickel-cobalt-aluminum composite hydroxide represented by Ni_{0.91}Co_{0.06}Al_{0.03}(OH)₂ was obtained by coprecipitation and heated at 500° C. LiOH and the resulting oxide were mixed in Ishikawa's grinding mortar in a molar ratio of 1.05:1 between Li and all transition metals. The mixture was then heated at 760° C. for 20 hours in an oxygen atmosphere and milled, giving particles of a lithium-nickel-cobalt-aluminum composite oxide (lithium transition metal oxide) represented by Li_{1.05}Ni_{0.91}CO_{0.06}Al_{0.03}O₂ with an average secondary particle diameter of approximately 11 μm.

A thousand grams of such lithium transition metal oxide particles were prepared, added to 1.5 L of purified water, and stirred to give a suspension of the lithium transition metal oxide in purified water. Then a 0.1 mol/L aqueous solution of erbium sulfate obtained by dissolving erbium oxide in sulfuric acid was added in portions to the suspension. The pH of the suspension while the aqueous solution of erbium sulfate was added thereto was between 11.5 and 12.0. The suspension was then filtered, and the resulting powder was washed with pure and dried at 200° C. in a vacuum.

The resulting powder was sprayed with a 1.0 mol/L aqueous solution of magnesium sulfate and dried. The product was used as the positive electrode active material. The central diameter (D50, by volume) of the resulting positive electrode active material particles was approximately 10 μm (measured using HORIBA LA920).

The surface of the resulting positive electrode active material was observed using a SEM, finding that primary particles of an erbium compound having an average diameter of 20 to 30 nm had aggregated into secondary particles of the erbium compound having an average diameter of 100 to 200 nm, and the secondary particles were adhering to the surface of secondary particles of the lithium transition metal oxide. Most of the secondary particles of the erbium compound were adhering to depressions formed between adjacent primary particles of the lithium transition metal oxide on the surface of the secondary particles of the lithium transition metal oxide, touching both of the adjacent primary particles at the depressions. The amount of adhering erbium compound as measured by ICP emission spectrometry was 0.15% by mass of the lithium-nickel-cobalt-aluminum composite oxide on an elemental erbium basis.

In Experimental Example 1, primary particles of erbium hydroxide that precipitated in the suspension bonded (aggregated) together into secondary particles presumably because the pH of the suspension was high, between 11.5 and 12.0. In Experimental Example 1, moreover, the percentage of Ni was as high as 91%, which means that the percentage of trivalent Ni was high. Owing to this, proton exchange easily occurred between LiNiO₂ and H₂O at the interfaces between primary particles of the lithium transition metal oxide, and a large amount of LiOH resulting from the proton exchange came out from the inside of the interfaces, between a primary particle and another, on the surface of secondary particles of the lithium transition metal oxide. This increased alkali concentration in the spaces between adjacent primary particles on the surface of the lithium transition metal oxide. As a result, the inventors believe, the erbium hydroxide particles that precipitated in the suspension did so in such a manner that they formed secondary particles and aggregated at the depressions formed at the interfaces between the primary particles, by virtue of attraction by the alkali.

On the surface of the secondary particles of the lithium transition metal oxide, furthermore, particles of a magnesium compound were found uniformly dispersed. The amount of adhering magnesium compound as measured by ICP emission spectrometry was 0.1 mol % of the total number of moles of non-Li metal elements.

### [Preparation of a Positive Electrode]

The positive electrode active material particles, carbon black, and a solution of polyvinylidene fluoride in N-methyl-2-pyrrolidone were weighed out in a mass ratio of 100:1:1 between the positive electrode active materials, the conductor, and the binder and kneaded using T. K. HIVIS MIX (PRIMIX Corporation) into positive electrode mixture slurry.

The positive electrode mixture slurry was then applied to both sides of a positive electrode current collector that was aluminum foil. After drying, the coatings were rolled with a roller. An aluminum current collector tab was attached to the current collector to complete a positive electrode plate as a positive electrode current collector with a positive electrode mixture layer formed on both sides thereof. The packing density of the positive electrode active material in this positive electrode was 3.60 g/cm³.

### [Preparation of a Negative Electrode]

Artificial graphite as the negative electrode active material, CMC (sodium carboxymethyl cellulose), and SBR (styrene-butadiene rubber) were mixed in an aqueous solution in a mass ratio of 100:1:1 to give negative electrode mixture slurry. The negative electrode mixture slurry was applied uniformly to both sides of a negative electrode current collector that was copper foil. After drying, the coatings were rolled with a roller. A nickel current collector tab was attached to the current collector to complete a negative electrode plate as a negative electrode current collector with a negative electrode mixture layer formed on both sides thereof. The packing density of the negative electrode active material in this negative electrode was 1.75 g/cm³.

### [Preparation of a Nonaqueous Electrolyte]

Ethylene carbonate (EC), methyl ethyl carbonate (MEC), and dimethyl carbonate (DMC) were mixed in a volume ratio of 2:2:6, and lithium hexafluorophosphate (LiPF₆) was dissolved in the resulting solvent mixture to a concentration of 1.3 moles/liter. Then vinylene carbonate (VC) was dissolved in the solvent mixture at a concentration of 2.0% by mass.

### [Fabrication of a Battery]

The resulting positive and negative electrodes were wound in a spiral with the separator therebetween. The winding core was removed to give a spiral electrode element. This spiral electrode element was then compressed to give a flat electrode element. This flat electrode element and the nonaqueous electrolyte were inserted into an aluminum laminate sheath to complete battery A1. The size of the battery was 3.6 mm thick×35 mm wide×62 mm long. The discharge capacity of the nonaqueous electrolyte secondary battery when charged to 4.20 V and discharged to 3.0 V was 950 mAh.

### Experimental Example 2

Battery A2 was fabricated in the same way as in Experimental Example 1 except that in the preparation of the positive electrode active material, the aqueous solution of magnesium sulfate was not added.

### Experimental Example 3

A positive electrode active material was prepared in the same way as in Experimental Example 1 except that in the preparation of the positive electrode active material, the pH of the suspension while the aqueous solution of erbium sulfate was added to it was kept constant at 9. Using this positive electrode active material, battery A3 was fabricated. To adjust the pH of the suspension to 9, a 10% by mass aqueous solution of sodium hydroxide was added as needed.

The surface of the resulting positive electrode active material was observed using a SEM, finding that primary particles of erbium hydroxide having an average diameter of 10 nm to 50 nm were adhering to the surface of secondary particles of the lithium transition metal oxide, dispersed uniformly over the entire surface (both projections and depressions) without forming secondary particles. The amount of adhering erbium compound as measured by ICP emission spectrometry was 0.15% by mass of the lithium-nickel-cobalt-aluminum composite oxide on an elemental erbium basis.

In Experimental Example 3, particles of erbium hydroxide were slow to precipitate in the suspension and separated out uniformly over the entire surface of secondary particles of the lithium transition metal oxide without forming secondary particles presumably because the pH of the suspension was set to 9.

### Experimental Example 4

Battery A4 was fabricated in the same way as in Experimental Example 3 except that in the preparation of the positive electrode active material, the aqueous solution of magnesium sulfate was not added.

### Experimental Example 5

A positive electrode active material was prepared in the same way as in Experimental Example 1 except that in the preparation of the positive electrode active material, the aqueous solution of erbium sulfate was not added, and, therefore, the attachment of erbium hydroxide to the surface of secondary particles of the lithium transition metal oxide was omitted. Using this positive electrode active material, battery A5 was fabricated.

### Experimental Example 6

Battery A6 was fabricated in the same way as in Experimental Example 5 except that in the preparation of the positive electrode active material, the aqueous solution of magnesium sulfate was not added.

<Measurement of the Capacity Recovery after High-Temperature Storage>

For each of these batteries, the capacity recovery after high-temperature storage was measured under the following conditions. At 25° C., the battery was charged to 4.2 V at a constant current of 1 C and then at a constant voltage of 4.2 V until the current value reached 0.05 C (this charge is referred to as charge A). After a 10-minute rest, the battery was discharged at a constant current of 1 C until 2.5 V (this discharge is referred to as discharge A), and the discharge capacity was defined as the capacity before storage. After a 10-minute rest, the battery underwent charge A only and then was stored at 60° C. for 20 days. After the storage, the battery was allowed to cool to room temperature and underwent discharge A only. Charge A was performed after a 10-minute rest, and discharge A was performed after a 10-minute rest. The discharge capacity during this was defined as recovered capacity. The capacity recovery after high-temperature storage was determined according to the equation below. The results are presented in Table 1.

Capacity recovery after high-temperature storage (%)=(Recovered capacity/Capacity before storage)×100

TABLE 1

| | | | Amount of | Capacity |
|---|---|---|---|---|
| | | | adhering | recovery |
| | Rare | Adhesion of | Mg | after high- |
| | earth | rare earth | compound | temperature |
| Battery | element | compound | (mol %) | storage (%) |
| A1 | Er | Aggregation at | 0.1 | 94.2 |
| | | depressions | | |
| A2 | Er | Aggregation at | 0.0 | 92.4 |
| | | depressions | | |
| A3 | Er | Uniform | 0.1 | 92.8 |
| | | dispersion | | |
| A4 | Er | Uniform | 0.0 | 92.3 |
| | | dispersion | | |
| A5 | None | — | 0.1 | 93.1 |
| A6 | None | — | 0.0 | 92.7 |

First, the capacity recovery after high-temperature storage of battery A6, made using a positive electrode active material containing no rare earth compound and no magnesium compound, was 92.7%. Battery A5, made using a positive electrode active material that contained no rare earth compound but contained a magnesium compound, exhibited a higher capacity recovery after high-temperature storage than battery A6. This is, the inventors believe, because the magnesium compound reduced the reactivity of the surface of secondary particles of the lithium transition metal oxide with the electrolyte and other materials during high-temperature storage and thereby controlled the alteration of the surface of the secondary particles.

Batteries A2 and A4, made using a positive electrode active material that contained no magnesium compound but contained a rare earth compound, had a lower capacity recovery after high-temperature storage than battery A6. This is because the storage at a high temperature caused the rare earth compound to alter by reacting with the electrolyte and other materials. The altered rare earth compound, moreover, may have failed to inhibit the reaction of the surface of secondary particles of the lithium transition metal oxide with the electrolyte and other materials (or probably rather promoted the reaction), resulting in the alteration of the surface of the secondary particles.

As for battery A1, made using a positive electrode active material in which secondary particles of a rare earth compound were adhering to both of the adjacent primary particles of a lithium transition metal oxide at depressions on secondary particles of the oxide with a magnesium compound adhering to the surface of the secondary particles of the lithium transition metal oxide, the capacity recovery after high-temperature storage was higher than those of batteries A5 and A6. This is because the magnesium compound not only inhibited the reaction of the surface of secondary particles of the lithium transition metal oxide with the electrolyte and other materials but also controlled the alteration of the rare earth compound, or, in other words, because the magnesium compound and the rare earth compound, whose alteration was limited, worked in synergy to provide greater control of the alteration of the surface of secondary particles of the lithium transition metal oxide. It is to be noted that although the difference in capacity recovery after high-temperature storage between battery A1 and batteries A5 and A6 is a few percentage points, even this difference of a few percentage points will manifest itself as a very large difference in capacity in the end, given that nonaqueous electrolyte secondary batteries have a life cycle of years or longer.

The capacity recovery after high-temperature storage of battery A3, in which a rare earth compound and a magnesium compound were adhering to (were dispersed uniformly over) the entire surface of secondary particles of a lithium transition metal oxide, was comparable to that of battery A6 and was a low compared with that of battery A5. This is because when the rare earth compound is dispersed uniformly on the surface of secondary particles of the lithium transition metal oxide, the synergy between a magnesium compound and a rare earth compound with limited alteration is hardly achieved because of low effectiveness of the magnesium compound in controlling the surface alteration of the rare earth compound.

Overall, low capacity recovery after high-temperature storage can be prevented by using a positive electrode active material in which secondary particles of a rare earth compound are adhering to both of adjacent primary particles of a lithium transition metal oxide at depressions on secondary particles of the oxide with a magnesium compound adhering to the surface of the secondary particles of the lithium transition metal oxide.

### Second Experiment

### Experimental Example 7

Battery A7 was fabricated in the same way as in Experimental Example 1 except that in the preparation of the positive electrode active material, the amount of adhering magnesium compound was adjusted to 0.2 mol % of the total number of moles of non-Li metal elements in the lithium transition metal oxide.

### Experimental Example 8

Battery A8 was fabricated in the same way as in Experimental Example 1 except that in the preparation of the positive electrode active material, the amount of adhering magnesium compound was adjusted to 0.5 mol % of the total number of moles of non-Li metal elements in the lithium transition metal oxide.

The measured capacity recovery after high-temperature storage of batteries A7 and A8 are presented in Table 2, along with the results for batteries A1 and A2.

TABLE 2

| | | | Amount of | Capacity |
|---|---|---|---|---|
| | | | adhering | recovery |
| | Rare | Adhesion of | Mg | after high- |
| | earth | rare earth | compound | temperature |
| Battery | element | compound | (mol %) | storage (%) |
| A2 | Er | Aggregation at | 0.0 | 92.4 |
| | | depressions | | |
| A1 | Er | Aggregation at | 0.1 | 94.2 |
| | | depressions | | |
| A7 | Er | Aggregation at | 0.2 | 94.1 |
| | | depressions | | |
| A8 | Er | Aggregation at | 0.5 | 93.9 |
| | | depressions | | |

Batteries A7 and A8 were better than battery A2 in terms of capacity recovery after high-temperature storage, but when batteries A1, A7, and A8 are compared, the capacity recovery after high-temperature storage decreased with increasing amount of adhering magnesium compound. This is, the inventors believe, due to increased surface resistance of secondary particles of the lithium transition metal oxide associated with the increase in the amount of adhering magnesium compound.

### Experimental Example 9

A positive electrode active material was prepared in the same way as in Experimental Example 1 except that in the preparation of the positive electrode active material, the aqueous solution of erbium sulfate was replaced with a solution of samarium sulfate. Using this positive electrode active material, battery A9 was fabricated. The amount of adhering samarium compound as measured by ICP emission spectrometry was 0.12% by mass of the lithium-nickel-cobalt-aluminum composite oxide on an elemental samarium basis.

### Experimental Example 10

A positive electrode active material was prepared in the same way as in Experimental Example 1 except that in the preparation of the positive electrode active material, the aqueous solution of erbium sulfate was replaced with a solution of neodymium sulfate. Using this positive electrode active material, battery A10 was fabricated. The amount of adhering neodymium compound as measured by ICP emission spectrometry was 0.11% by mass of the lithium-nickel-cobalt-aluminum composite oxide on an elemental neodymium basis.

The measured capacity recovery after high-temperature storage of batteries A9 and A10 are presented in Table 3, along with the results for battery A1.

TABLE 3

| | | | Amount of | Capacity |
|---|---|---|---|---|
| | | | adhering | recovery |
| | Rare | Adhesion of | Mg | after high- |
| | earth | rare earth | compound | temperature |
| Battery | element | compound | (mol %) | storage (%) |
| A1 | Er | Aggregation | 0.1 | 94.2 |
| | | at depressions | | |
| A9 | Sm | Aggregation | 0.1 | 94.2 |
| | | at depressions | | |
| A10 | Nd | Aggregation | 0.1 | 94.2 |
| | | at depressions | | |

As can be seen from Table 3, low capacity recovery after high-temperature storage was prevented even with the use of samarium or neodymium, which are rare earth elements as erbium is. This suggests that the use of a rare earth element other than erbium, samarium, and neodymium will also prevent low capacity recovery after high-temperature storage likewise.

### INDUSTRIAL APPLICABILITY

The present invention can be applied to a positive electrode active material for nonaqueous electrolyte secondary batteries, a positive electrode for nonaqueous electrolyte secondary batteries, a nonaqueous electrolyte secondary battery, and a method for producing a positive electrode active material for nonaqueous electrolyte secondary batteries.

### REFERENCE SIGNS LIST

1 Positive electrode
2 Negative electrode
3 Separator
4 Positive electrode current collector tab
5 Negative electrode current collector tab
6 Aluminum laminate sheath
7 Closed portion
11 Nonaqueous electrolyte secondary battery
20 Primary particle of a lithium transition metal oxide (primary particle)
21 Secondary particle of a lithium transition metal oxide (secondary particle)
23 Depression
24 Primary particle of a rare earth compound (primary particle)
25 Secondary particle of a rare earth compound (secondary particle)
26 Magnesium compound

1. A positive electrode active material for a nonaqueous electrolyte secondary battery, the material comprising:
secondary particles of a lithium transition metal oxide resulting from aggregation of primary particles of the oxide;
secondary particles of at least one rare earth compound resulting from aggregation of primary particles of the compound; and
at least one magnesium compound, wherein:
the secondary particles of the rare earth compound are adhering to depressions formed between adjacent primary particles of the lithium transition metal oxide on a surface of the secondary particles of the lithium transition metal oxide and also to each of the primary particles forming the depressions; and
the magnesium compound is adhering to the surface of the secondary particles of the lithium transition metal oxide.

2. The positive electrode active material according to claim 1 for a nonaqueous electrolyte secondary battery, wherein the adhering magnesium compound is in an amount of 0.03 mol % or more and 0.5 mol % or less of a total number of moles of non-lithium metal elements in the lithium transition metal oxide.

3. The positive electrode active material according to claim 1 for a nonaqueous electrolyte secondary battery, wherein the at least one magnesium compound includes magnesium hydroxide.

4. The positive electrode active material according to claim 1 for a nonaqueous electrolyte secondary battery, wherein the at least one rare earth compound includes a rare earth hydroxide.

5. The positive electrode active material according to claim 1 for a nonaqueous electrolyte secondary battery, wherein:
the lithium transition metal oxide contains Ni, Co, and Al; and
a percentage of Ni in the lithium transition metal oxide is 80 mol % or more of a total number of moles of non-lithium metal elements.

6. The positive electrode active material according to claim 1 for a nonaqueous electrolyte secondary battery, wherein the magnesium compound is also adhering to a surface of secondary particles of the rare earth compound.

7. A positive electrode for a nonaqueous electrolyte secondary battery, the electrode comprising a positive electrode active material according to claim 1 for a nonaqueous electrolyte secondary battery.

8. A nonaqueous electrolyte secondary battery comprising a positive electrode that contains a positive electrode active material according to claim 1 for a nonaqueous electrolyte secondary battery.

9. A method for producing a positive electrode active material for a nonaqueous electrolyte secondary battery, the method comprising:
attaching step A, in which secondary particles of a rare earth compound are attached to depressions formed between adjacent primary particles of a lithium transition metal oxide on a surface of secondary particles of the oxide that are secondary particles resulting from aggregation of the primary particles, and also to each of the primary particles forming the depressions; and
attaching step B, in which a magnesium compound is attached to the surface of the secondary particles of the lithium transition metal oxide.

10. The method according to claim 9 for producing a positive electrode active material for a nonaqueous electrolyte secondary battery, wherein:
attaching step A includes a heat treatment step in which the lithium transition metal oxide is heated with the secondary particles of the rare earth compound adhering thereto; and
attaching step B is performed after the heat treatment step.
